(19) United States
(12) Patent Application Publication
(10) Pub. No.: US 2026/0186669 A1
(43) Pub. Date: Jul. 2, 2026

(54) STORAGE DEVICE FOR DETERMINING WHETHER TO REBUILD MAP UNIT STORED IN HOST MEMORY BUFFER, AND OPERATING METHOD OF THE SAME

(71) Applicant: SK hynix Inc., Icheon-si (KR)

(72) Inventors: Ji Hun CHOI, Icheon-si (KR); Min Su SON, Icheon-si (KR); Jung Ho LEE, Icheon-si (KR); Soong Sun SHIN, Icheon-si (KR)

(21) Appl. No.: 19/189,149

(22) Filed: Apr. 24, 2025

(30) Foreign Application Priority Data
Dec. 27, 2024 (KR) 10-2024-0197845

(51) Int. Cl. G06F 3/06

(52) U.S. Cl. CPC G06F 3/0619; G06F 3/0659; G06F 3/0673

(57) ABSTRACT

A storage device may include a memory storing a plurality of map units included in a mapping table that indicates a mapping relationship between a plurality of logical addresses and a plurality of physical addresses, each of the plurality of map units indicating a mapping relationship between one or more logical addresses and one or more physical addresses, and a controller configured to load a target map unit, from among the plurality of map units, into a host memory buffer located outside the storage device, and when a target operation is executed, determine whether to rebuild the target map unit by comparing tag information of the target map unit with tag information of target data in the memory corresponding to the target map unit.

### CROSS-REFERENCE TO RELATED APPLICATION

The present application claims priority under 35 U.S.C. § 119(a) to Korean patent application number 10-2024-0197845 filed in the Korean Intellectual Property Office on Dec. 27, 2024, which is incorporated herein by reference in its entirety.

### TECHNICAL FIELD

Embodiments of the present disclosure relate to a storage device for determining whether to rebuild a map unit in a host memory buffer and an operating method of the storage device.

### BACKGROUND

A storage device is a device for storing data according to a request from an external device such as a computer, a mobile terminal (e.g., a smart phone or tablet), or the like.

A storage device may include a memory for storing data therein and a controller for controlling the memory. The memory may be a volatile memory or a non-volatile memory. The controller may receive a command from an external device (i.e., a host), and execute or control operations to read, write, or erase data in the memory included in the storage device according to the received command.

A storage device may store a mapping table in memory that indicates a mapping relationship between a plurality of logical addresses and a plurality of physical addresses. The mapping table may be used to search for a physical address of data corresponding to a specific logical address during a read operation, and to record a physical address where data corresponding to a specific logical address is written during a write operation.

### SUMMARY

Embodiments of the disclosure may provide a storage device capable of preventing errors that occur when a map unit loaded into a host memory buffer is rolled back and enhancing the reliability of a map unit loaded into a host memory buffer, and an operating method of the storage device.

The objects of the embodiments of the present disclosure are not limited to the objects described in this specification, and other objects not mentioned will be clearly understood by those skilled in the art from the description below.

Embodiments of the present disclosure may provide a storage device including a memory storing a plurality of map units included in a mapping table that indicates a mapping relationship between a plurality of logical addresses and a plurality of physical addresses, each of the plurality of map units indicating a mapping relationship between one or more logical addresses and one or more physical addresses, and a controller configured to load a target map unit, from among the plurality of map units, into a host memory buffer located outside the storage device, and when a target operation is executed, determine whether to rebuild the target map unit by comparing tag information of the target map unit with tag information of target data in the memory corresponding to the target map unit.

Embodiments of the present disclosure may provide an operating method of a storage device including loading a target map unit, from among a plurality of map units included in a mapping table that indicates a mapping relationship between a plurality of logical addresses and a plurality of physical addresses, from a memory storing the mapping table to a host memory buffer located outside the storage device, comparing tag information of the target map unit with tag information of target data corresponding to the target map unit when a target operation is executed, and determining whether to rebuild the target map unit based on a result of the comparison.

According to embodiments of the present disclosure, it is possible to provide a storage device capable of preventing errors that occur when a map unit loaded into a host memory buffer is rolled back and enhancing the reliability of a map unit loaded into a host memory buffer, and an operating method of the storage device.

The effects of the embodiments of the present disclosure are not limited to the effects mentioned above, and other effects not mentioned will be clearly understood by those skilled in the art from the description of the claims.

### BRIEF DESCRIPTION OF THE DRAWINGS

The present disclosure will be more fully understood from the detailed description and accompanying drawings provided below, which are provided for illustration only and are not intended to limit the present disclosure.

FIG. 1 is a schematic configuration diagram of a storage device according to an embodiment of the present disclosure.

FIG. 2 is a block diagram schematically illustrating a memory of FIG. 1.

FIG. 3 illustrates a schematic structure of a storage device according to an embodiment of the present disclosure.

FIG. 4 is a flowchart illustrating an operation of a storage device according to an embodiment of the present disclosure.

FIG. 5 illustrates tag information of a target map unit and tag information of target data according to an embodiment of the present disclosure.

FIG. 6 illustrates an example of an operation for determining tag information of target data according to an embodiment of the present disclosure.

FIG. 7 illustrates another example of an operation for determining tag information of target data according to an embodiment of the present disclosure.

FIG. 8 illustrates another example of an operation for determining tag information of target data according to an embodiment of the present disclosure.

FIG. 9 is a flowchart illustrating an operation for determining whether a storage device rebuilds a target map unit according to an embodiment of the present disclosure.

FIG. 10 is a flowchart illustrating an operation of a storage device rebuilding a target map unit according to an embodiment of the present disclosure.

FIG. 11 illustrates an operating method of a storage device according to an embodiment of the present disclosure.

### DETAILED DESCRIPTION

Hereinafter, embodiments of the present disclosure will be described in detail with reference to accompanying drawings. In the following description of examples or embodiments of the present invention, reference will be made to the accompanying drawings in which it is shown by way of illustration specific examples or embodiments that can be implemented, and in which the same reference numerals and signs can be used to designate the same or like components even when they are shown in different accompanying drawings. Further, in the following description of examples or embodiments of the present invention, detailed descriptions of well-known functions and components incorporated herein will be omitted when it is determined that the description may make the subject matter in some embodiments of the present invention more unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present invention. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, or manufacturing methods, these terms may be used to describe non-consecutive or non-sequential processes or operations unless the term “directly” or “immediately” is used together.

In addition, when any dimensions, relative sizes etc. are mentioned, it should be considered that numerical values for elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, various embodiments of the present disclosure will be described in detail with reference to the accompanying drawings.

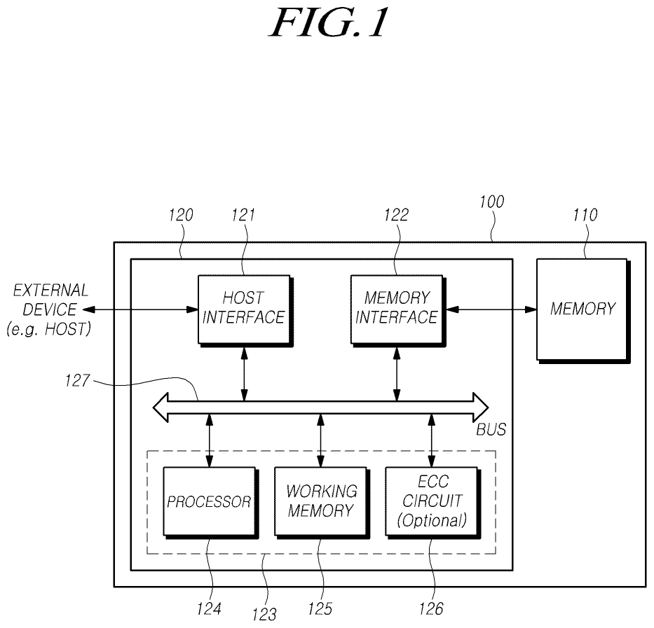

FIG. 1 is a schematic configuration diagram of a storage device according to an embodiment of the disclosure.

Referring to FIG. 1, a storage device 100 may include a memory 110 that stores data and a controller 120 that controls the memory 110.

The memory 110 includes a plurality of memory blocks, and operates in response to the control of the controller 120. Operations of the memory 110 may include, for example, a read operation, a program operation (also referred to as a write operation) and an erase operation.

The memory 110 may include a memory cell array including a plurality of memory cells (also simply referred to as “cells”) that store data.

For example, the memory 110 may be realized in various types of memory such as a DDR SDRAM (double data rate synchronous dynamic random access memory), an LPDDR4 (low power double data rate 4) SDRAM, a GDDR (graphics double data rate) SDRAM, an LPDDR (low power DDR), an RDRAM (Rambus dynamic random access memory), a NAND flash memory, a 3D NAND flash memory, a NOR flash memory, a resistive random access memory (RRAM), a phase-change memory (PRAM), a magnetoresistive random access memory (MRAM), a ferroelectric random access memory (FRAM) and a spin transfer torque random access memory (STT-RAM).

The memory 110 may be implemented as a three-dimensional array structure. For example, embodiments of the disclosure may be applied to a charge trap flash (CTF) in which a charge storage layer is configured by a dielectric layer and a flash memory in which a charge storage layer is configured by a conductive floating gate.

The memory 110 may receive a command and an address from the controller 120 and may access an area in the memory cell array that is selected by the address. In other words, the memory 110 may perform an operation indicated by the command, on the area selected by the address.

The memory 110 may perform a program operation, a read operation or an erase operation. For example, when performing the program operation, the memory 110 may program data to the area selected by the address. When performing the read operation, the memory 110 may read data from the area selected by the address. In the erase operation, the memory 110 may erase data stored in the area selected by the address.

The controller 120 may control write (program), read, erase and background operations for the memory 110. For example, background operations may include at least one from among a garbage collection (GC) operation, a wear leveling (WL) operation, a read reclaim (RR) operation, a bad block management (BBM) operation, and so forth.

The controller 120 may control the operation of the memory 110 according to a request from a device (e.g., a host) located outside the storage device 100. The controller 120, however, also may control the operation of the memory 110 regardless of a request of the host.

The host may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, an RFID (radio frequency identification) device, and a mobility device (e.g., a vehicle, a robot or a drone) capable of driving under human control or autonomous driving, as non-limiting examples. Alternatively, the host may be a virtual reality (VR) device providing 2D or 3D virtual reality images or an augmented reality (AR) device providing augmented reality images. The host may be any one of various electronic devices that require the storage device 100 to be capable of storing data.

The host may include at least one operating system (OS). The operating system may generally manage and control the function and operation of the host, and may control interoperability between the host and the storage device 100. The operating system may be classified into a general operating system and a mobile operating system depending on the mobility of the host.

The controller 120 and the host may be devices that are separated from each other, or the controller 120 and the host may be integrated into one device. Hereunder, for the sake of convenience in explanation, descriptions will describe the controller 120 and the host as devices that are separated from each other.

Referring to FIG. 1, the controller 120 may include a memory interface 122 and a control circuit 123, and may further include a host interface 121.

The host interface 121 provides an interface for communication with the host. For example, the host interface 121 provides an interface that uses at least one from among various interface protocols such as a USB (universal serial bus) protocol, an MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol, an IDE (integrated drive electronics) protocol and a private protocol.

When receiving a command from the host, the control circuit 123 may receive the command through the host interface 121, and may perform an operation of processing the received command.

The memory interface 122 may be coupled with the memory 110 to provide an interface for communication with the memory 110. That is to say, the memory interface 122 may be configured to provide an interface between the memory 110 and the controller 120 in response to the control of the control circuit 123.

The control circuit 123 performs the general control operations of the controller 120 to control the operation of the memory 110. To this end, for instance, the control circuit 123 may include at least one of a processor 124 and a working memory 125, and may optionally include an error detection and correction circuit (ECC circuit) 126.

The processor 124 may control general operations of the controller 120, and may perform a logic calculation. The processor 124 may communicate with the host through the host interface 121, and may communicate with the memory 110 through the memory interface 122.

The processor 124 may execute logical operations required to perform the function of a flash translation layer (FTL). The processor 124 may translate a logical block address (LBA), provided by the host, into a physical block address (PBA) through the flash translation layer. The flash translation layer may receive the logical block address and translate the logical block address into the physical block address, by using a mapping table.

There are various address mapping methods of the flash translation layer, depending on a mapping unit. Representative address mapping methods include a page mapping method, a block mapping method and a hybrid mapping method.

The processor 124 may randomize data received from the host. For example, the processor 124 may randomize data received from the host by using a set randomizing seed. The randomized data may be provided to the memory 110, and may be programmed to a memory cell array of the memory 110.

In a read operation, the processor 124 may derandomize data received from the memory 110. For example, the processor 124 may derandomize data received from the memory 110 by using a derandomizing seed. The derandomized data may be outputted to the host.

The processor 124 may execute firmware to control the operation of the controller 120. Namely, in order to control the general operation of the controller 120 and perform a logic calculation, the processor 124 may execute or drive firmware loaded in the working memory 125 upon booting. Hereafter, an operation of the storage device 100 according to embodiments of the disclosure will be described as implementing a processor 124 that executes firmware in which the corresponding operation is defined.

Firmware, as a program to be executed in the storage device 100 to drive the storage device 100, may include various functional layers. For example, the firmware may include binary data in which codes for executing the functional layers, respectively, are defined.

For example, the firmware may include at least one from among a flash translation layer, which performs a translating function between a logical address requested to the storage device 100 from the host and a physical address of the memory 110; a host interface layer (HIL), which serves to analyze a command requested to the storage device 100 as a storage device from the host and transfer the command to the flash translation layer; and a flash interface layer (FIL), which transfers a command, instructed from the flash translation layer, to the memory 110.

Such firmware may be loaded in the working memory 125 from, for example, the memory 110 or a separate nonvolatile memory (e.g., a ROM or a NOR Flash) located outside the memory 110. The processor 124 may first load all or a part of the firmware in the working memory 125 when executing a booting operation after power-on.

The processor 124 may perform a logic calculation, which is defined in the firmware loaded in the working memory 125, to control the general operation of the controller 120. The processor 124 may store a result of performing the logic calculation defined in the firmware, in the working memory 125. The processor 124 may control the controller 120 according to a result of performing the logic calculation defined in the firmware such that the controller 120 generates a command or a signal. When a part of firmware, in which a logic calculation to be performed is defined, is stored in the memory 110, but not loaded in the working memory 125, the processor 124 may generate an event (e.g., an interrupt) for loading the corresponding part of the firmware into the working memory 125 from the memory 110.

The processor 124 may load metadata necessary for driving firmware from the memory 110. The metadata, as data for managing the memory 110, may include for example management information on user data stored in the memory 110.

Firmware may be updated while the storage device 100 is manufactured or while the storage device 100 is operating. The controller 120 may download new firmware from the outside of the storage device 100 and update existing firmware with the new firmware.

To drive the controller 120, the working memory 125 may store necessary firmware, a program code, a command and data. The working memory 125 may be a volatile memory that includes, for example, at least one from among an SRAM (static RAM), a DRAM (dynamic RAM) and an SDRAM (synchronous DRAM). Meanwhile, the controller 120 may additionally use a separate volatile memory (e.g. SRAM, DRAM) located outside the controller 120 in addition to the working memory 125.

The error detection and correction circuit 126 may detect an error bit of target data, and correct the detected error bit by using an error correction code. The target data may be, for example, data stored in the working memory 125 or data read from the memory 110.

The error detection and correction circuit 126 may decode data by using an error correction code. The error detection and correction circuit 126 may be realized by various code decoders. For example, a decoder that performs unsystematic code decoding or a decoder that performs systematic code decoding may be used.

For example, the error detection and correction circuit 126 may detect an error bit by the unit of a set sector in each of the read data, when each read data is constituted by a plurality of sectors. A sector may mean a data unit that is smaller than a page, which is the read unit of a flash memory. Sectors constituting each read data may be matched with one another using an address.

The error detection and correction circuit 126 may calculate a bit error rate (BER), and may determine whether an error is correctable or not, by sector units. For example, when a bit error rate is higher than a reference value, the error detection and correction circuit 126 may determine that a corresponding sector is uncorrectable or a fail. On the other hand, when a bit error rate is lower than the reference value, the error detection and correction circuit 126 may determine that a corresponding sector is correctable or a pass.

The error detection and correction circuit 126 may perform an error detection and correction operation sequentially for all read data. In the case where a sector included in read data is correctable, the error detection and correction circuit 126 may omit an error detection and correction operation for a corresponding sector for next read data. If the error detection and correction operation for all read data is ended in this way, then the error detection and correction circuit 126 may detect a sector that is uncorrectable in read data last. There may be one or more sectors that are determined to be uncorrectable. The error detection and correction circuit 126 may transfer information (e.g., address information) regarding a sector that is determined to be uncorrectable to the processor 124.

A bus 127 may be configured to provide channels among the components 121, 122, 124, 125 and 126 of the controller 120. The bus 127 may include, for example, a control bus for transferring various control signals, commands and the like, a data bus for transferring various data, and so forth.

Some components among the above-described components 121, 122, 124, 125 and 126 of the controller 120 may be omitted, or some components among the above-described components 121, 122, 124, 125 and 126 of the controller 120 may be integrated into one component. In addition to the above-described components 121, 122, 124, 125 and 126 of the controller 120, one or more other components may be added.

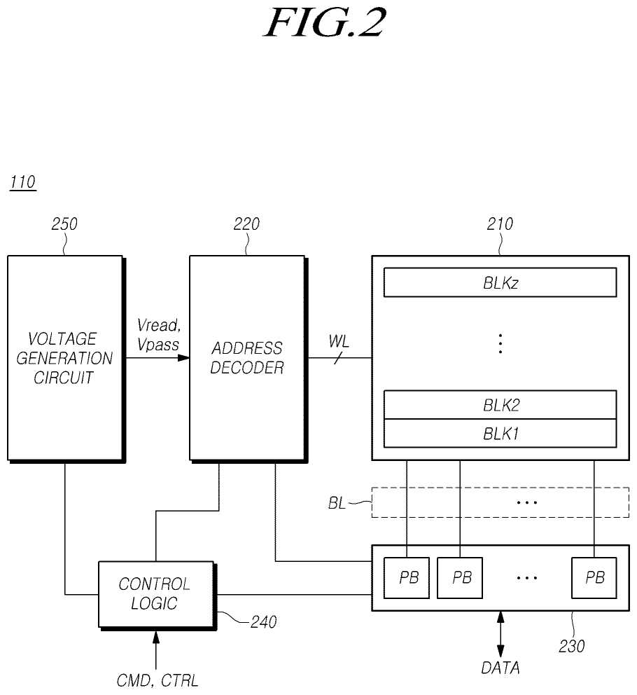

Hereinafter, the memory 110 will be described in further detail with reference to FIG. 2.

FIG. 2 is a block diagram schematically illustrating a memory 110 of FIG. 1.

Referring to FIG. 2, a memory 110 according to an embodiment of the disclosure may include a memory cell array 210, an address decoder 220, a read and write circuit 230, a control logic 240, and a voltage generation circuit 250.

The memory cell array 210 may include a plurality of memory blocks BLK1 to BLKz (where z is a natural number of 2 or greater).

In the plurality of memory blocks BLK1 to BLKz, a plurality of word lines WL and a plurality of bit lines BL may be disposed, and a plurality of memory cells may be arranged.

The plurality of memory blocks BLK1 to BLKz may be coupled with the address decoder 220 through the plurality of word lines WL. The plurality of memory blocks BLK1 to BLKz may be coupled with the read and write circuit 230 through the plurality of bit lines BL.

Each of the plurality of memory blocks BLK1 to BLKz may include a plurality of memory cells. For example, the plurality of memory cells may be nonvolatile memory cells, and may be configured by nonvolatile memory cells that have vertical channel structures.

The memory cell array 210 may be configured by a memory cell array of a two-dimensional structure or may be configured by a memory cell array of a three-dimensional structure.

Each of the plurality of memory cells included in the memory cell array 210 may store at least 1-bit data. For instance, each of the plurality of memory cells included in the memory cell array 210 may be a single level cell (SLC) that stores 1-bit data. In another instance, each of the plurality of memory cells included in the memory cell array 210 may be a multi-level cell (MLC) that stores 2-bit data. In still another instance, each of the plurality of memory cells included in the memory cell array 210 may be a triple level cell (TLC) that stores 3-bit data. In yet another instance, each of the plurality of memory cells included in the memory cell array 210 may be a quad level cell (QLC) that stores 4-bit data. In a further instance, the memory cell array 210 may include a plurality of memory cells, each of which stores 5 or more-bit data.

The number of bits of data stored in each of the plurality of memory cells may be dynamically determined. For example, a single-level cell that stores 1-bit data may be changed to a triple-level cell that stores 3-bit data.

Referring to FIG. 2, the address decoder 220, the read and write circuit 230, the control logic 240 and the voltage generation circuit 250 may operate as a peripheral circuit that drives the memory cell array 210.

The address decoder 220 may be coupled to the memory cell array 210 through the plurality of word lines WL.

The address decoder 220 may be configured to operate in response to the control of the control logic 240.

The address decoder 220 may receive an address through an input/output buffer in the memory 110. The address decoder 220 may be configured to decode a block address in the received address. The address decoder 220 may select at least one memory block depending on the decoded block address.

The address decoder 220 may receive a read voltage Vread and a pass voltage Vpass from the voltage generation circuit 250.

The address decoder 220 may apply the read voltage Vread to a selected word line WL in a selected memory block during a read operation, and may apply the pass voltage Vpass to the remaining unselected word lines WL.

The address decoder 220 may apply a verify voltage generated in the voltage generation circuit 250 to a selected word line WL in a selected memory block in a program verify operation, and may apply the pass voltage Vpass to the remaining unselected word lines WL.

The address decoder 220 may be configured to decode a column address in the received address. The address decoder 220 may transmit the decoded column address to the read and write circuit 230.

A read operation and a program operation of the memory 110 may be performed by the unit of a page. An address received when a read operation or a program operation is requested may include at least one from among a block address, a row address and a column address.

The address decoder 220 may select one memory block and one word line depending on a block address and a row address. A column address may be decoded by the address decoder 220 and be provided to the read and write circuit 230.

The address decoder 220 may include at least one from among a block decoder, a row decoder, a column decoder and an address buffer.

The read and write circuit 230 may include a plurality of page buffers PB. The read and write circuit 230 may operate as a read circuit in a read operation of the memory cell array 210, and may operate as a write circuit in a write operation of the memory cell array 210.

The read and write circuit 230 described above may also be referred to as a page buffer circuit or a data register circuit that includes a plurality of page buffers PB. The read and write circuit 230 may include data buffers that take charge of a data processing function, and may further include cache buffers that take charge of a caching function.

The plurality of page buffers PB may be coupled to the memory cell array 210 through the plurality of bit lines BL. The plurality of page buffers PB may continuously supply sensing current to bit lines BL coupled with memory cells to sense threshold voltages (Vth) of the memory cells in a read operation and a program verify operation, and may latch sensing data by sensing, through sensing nodes, changes in the amounts of current flowing, depending on the programmed states of the corresponding memory cells.

The read and write circuit 230 may operate in response to page buffer control signals outputted from the control logic 240.

In a read operation, the read and write circuit 230 temporarily stores read data by sensing data of memory cells, and then, outputs data DATA to the input/output buffer of the memory 110. As an exemplary embodiment, the read and write circuit 230 may include a column select circuit in addition to the page buffers PB or the page registers.

The control logic 240 may be coupled with the address decoder 220, the read and write circuit 230 and the voltage generation circuit 250. The control logic 240 may receive a command CMD and a control signal CTRL through the input/output buffer of the memory 110.

The control logic 240 may be configured to control general operations of the memory 110 in response to the control signal CTRL. The control logic 240 may output control signals for adjusting the precharge potential levels of the sensing nodes of the plurality of page buffers PB.

The control logic 240 may control the read and write circuit 230 to perform a read operation of the memory cell array 210. The voltage generation circuit 250 may generate the read voltage Vread and the pass voltage Vpass used in a read operation, in response to a voltage generation circuit control signal outputted from the control logic 240.

Each memory block of the memory 110 described above may be configured by a plurality of pages corresponding to a plurality of word lines WL and a plurality of strings corresponding to a plurality of bit lines BL.

In a memory block BLK, a plurality of word lines WL and a plurality of bit lines BL may be disposed to intersect with each other. For example, each of the plurality of word lines WL may be disposed in a row direction, and each of the plurality of bit lines BL may be disposed in a column direction. In another example, each of the plurality of word lines WL may be disposed in a column direction, and each of the plurality of bit lines BL may be disposed in a row direction.

A memory cell may be coupled to one of the plurality of word lines WL and one of the plurality of bit lines BL. A transistor may be disposed in each memory cell.

For example, a transistor disposed in each memory cell may include a drain, a source, and a gate. The drain (or source) of the transistor may be coupled with a corresponding bit line BL directly or via another transistor. The source (or drain) of the transistor may be coupled with a source line (which may be the ground) directly or via another transistor. The gate of the transistor may include a floating gate, which is surrounded by a dielectric, and a control gate to which a gate voltage is applied from a word line WL.

In each memory block, a first select line (also referred to as a source select line or a drain select line) may be additionally disposed outside a first outermost word line more adjacent to the read and write circuit 230 between two outermost word lines, and a second select line (also referred to as a drain select line or a source select line) may be additionally disposed outside a second outermost word line between the two outermost word lines.

At least one dummy word line may be additionally disposed between the first outermost word line and the first select line. At least one dummy word line may also be additionally disposed between the second outermost word line and the second select line.

A read operation and a program operation (e.g., write operation) of the memory block described above may be performed by the unit of a page, and an erase operation may be performed by the unit of a memory block.

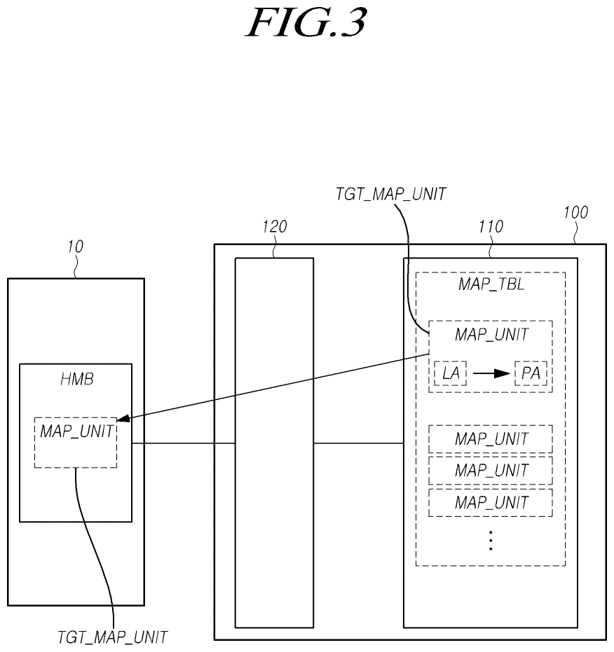

FIG. 3 illustrates a schematic structure of a storage device according to an embodiment of the present disclosure.

Referring to FIG. 3, a storage device 100 may include a memory 110 and a controller 120.

The memory 110 may store a mapping table MAP_TBL indicating a mapping relationship between a plurality of logical addresses and a plurality of physical addresses.

The mapping table MAP_TBL may include a plurality of map units MAP_UNIT. Each of the plurality of map units MAP_UNIT may indicate a mapping relationship between one or more logical addresses LA and one or more physical addresses PA.

The logical address may correspond to a start address of a logical address area of a fixed size (e.g., page size), and the physical address may correspond to a start address of a physical address area of a fixed size.

The map unit may be referred to as a map slice, a map chunk, etc.

The controller 120 may load a target map unit TGT_MAP_UNIT, from among a plurality of map units MAP_UNIT, into a host memory buffer HMB.

The host memory buffer HMB may be included in an external device 10, and the external device 10 may be a host. The external device 10 may allocate a portion of the memory area of the external device 10 to the storage device 100, and the allocated memory area may be referred to as a host memory buffer HMB.

The storage device 100 may store data in the allocated host memory buffer HMB and read data stored in the host memory buffer HMB.

As an example, the storage device 100 may store one or more of the plurality of map units MAP_UNIT in the host memory buffer HMB. As another example, the storage device 100 may store management data for managing or controlling the storage device 100. As another example, the storage device 100 may temporarily store user data to be written to the memory 110.

The host memory buffer HMB may be located in a volatile memory or non-volatile memory included in the external device 10.

In embodiments of the present disclosure, when there is not enough memory to store a plurality of map units MAP_UNIT inside the controller 120 (e.g., if the controller 120 does not include DRAM), the host memory buffer HMB may be used to perform the function of the flash translation layer FTL. That is, the controller 120 may load one or more of the plurality of map units MAP_UNIT into the host memory buffer HMB and obtain information on a physical address corresponding to a logical address by using the map unit loaded into the host memory buffer HMB.

The controller 120 may determine whether to rebuild the target map unit TGT_MAP_UNIT by comparing the tag information of the target map unit TGT_MAP_UNIT with the tag information of the target data corresponding to the target map unit TGT_MAP_UNIT when a set target operation is executed. When rebuilding the target map unit TGT_MAP_UNIT, the controller 120 may update the target map unit TGT_MAP_UNIT using other information stored in the memory 110.

In this case, the logical address corresponding to the target data may be included in the target map unit TGT_MAP_UNIT.

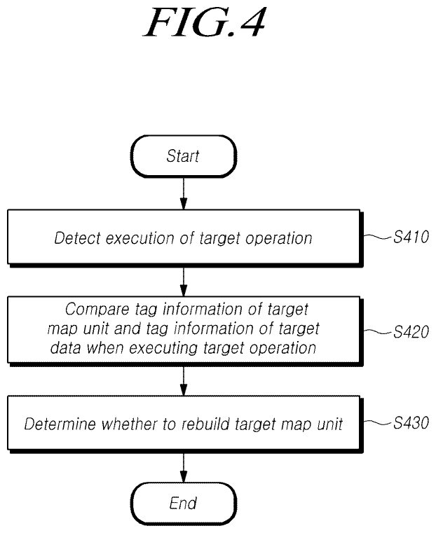

This will be described in detail in FIG. 4 below.

FIG. 4 is a flowchart illustrating an operation of a storage device according to an embodiment of the present disclosure.

Referring to FIG. 4, a controller 120 of a storage device 100 may detect the execution of a target operation (S410).

For example, the target operation may be an operation of reading a target map unit TGT_MAP_UNIT from a host memory buffer HMB, an operation of flushing a target map unit TGT_MAP_UNIT from a host memory buffer HMB to a memory 110, or an operation of scanning the validity of a target map unit TGT_MAP_UNIT.

The operation of reading a target map unit TGT_MAP_UNIT from a host memory buffer HMB may be executed by the controller 120 to process a read command when the host transmits a read command to the controller 120.

The operation of flushing the target map unit TGT_MAP_UNIT may mean an operation of writing the target map unit TGT_MAP_UNIT loaded in the host memory buffer HMB to a mapping table MAP_TBL stored in the memory 110.

In addition, the operation of scanning the validity of the target map unit TGT_MAP_UNIT may mean an operation of detecting an error in the target map unit TGT_MAP_UNIT. The scan operation may be executed periodically before flushing the target map unit TGT_MAP_UNIT to the memory 110 or when the host is in an idle state.

In addition, the controller 120 may compare the tag information of the target map unit TGT_MAP_UNIT with the tag information of the target data when the target operation is executed (S420). The tag information may also be referred to in terms such as age information and time information.

To this end, the controller 120 may read the tag information of the target map unit TGT_MAP_UNIT from the host memory buffer HMB, and may read the target data and the tag information of the target data from the memory 110 using the mapping relationship indicated by the target map unit TGT_MAP_UNIT.

In addition, the controller 120 may determine whether to rebuild the target map unit TGT_MAP_UNIT based on the comparison result performed in step S420 (S430).

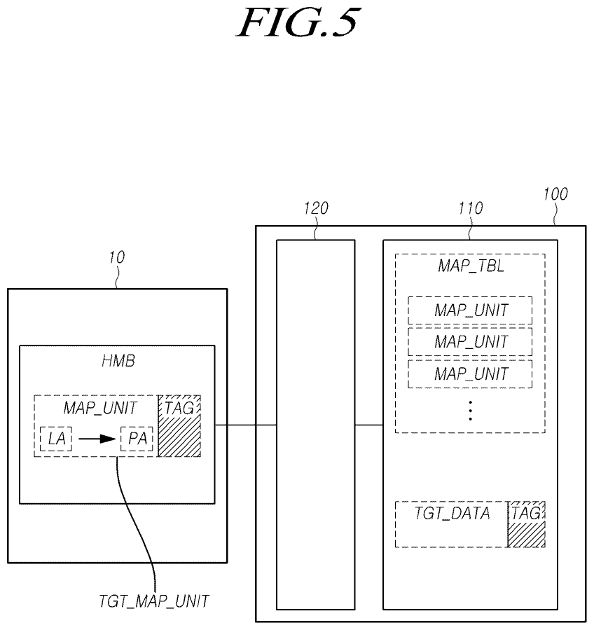

FIG. 5 illustrates tag information of a target map unit and tag information of target data according to an embodiment of the present disclosure.

Referring to FIG. 5, a target map unit TGT_MAP_UNIT and tag information of the target map unit TGT_MAP_UNIT may be stored in a host memory buffer HMB.

In addition, the tag information of the target data TGT_DATA may be stored in the memory 110. For example, the tag information of the target data TGT_DATA may be stored in a spare area of the page storing the target data TGT_DATA. Metadata about the target data TGT_DATA may be stored in the spare area, and the tag information may also be stored together with the metadata.

The controller 120 of the storage device 100 may read the tag information of the target map unit TGT_MAP_UNIT and the target map unit TGT_MAP_UNIT together from the host memory buffer HMB and may read the tag information of the target data TGT_DATA and the target data TGT_DATA together from the memory 110 in order to compare the tag information of the target map unit TGT_MAP_UNIT and the tag information of the target data TGT_DATA.

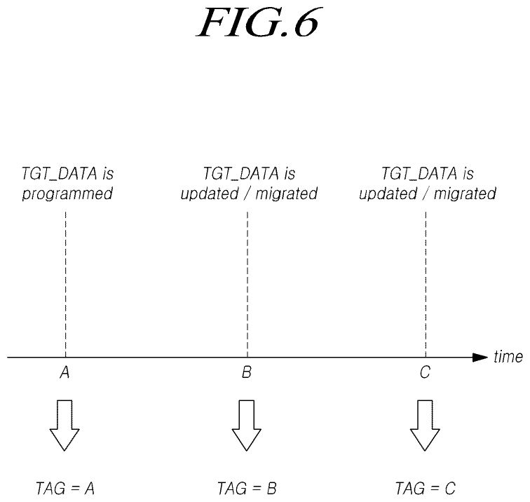

The tag information of the target data TGT_DATA described above may be determined in various ways. This will be described in detail in FIGS. 6 to 8 below.

FIG. 6 illustrates an example of an operation of determining tag information of target data according to an embodiment of the present disclosure.

Referring to FIG. 6, tag information of target data TGT_DATA may indicate a time point at which target data TGT_DATA has been last programmed in a memory 110.

If an update operation or migration operation for the target data TGT_DATA is not executed after the target data TGT_DATA is programmed in the memory 110, then the tag information of the target data TGT_DATA may indicate the time point at which the target data TGT_DATA was programmed in the memory 110.

On the other hand, if the target data TGT_DATA is programmed in the memory 110 and then an update operation or a migration operation (e.g., wear leveling operation, garbage collection operation) for the target data TGT_DATA is executed, then the tag information of the target data TGT_DATA may indicate a time point when the update operation or the migration operation for the target data TGT_DATA was last executed.

In FIG. 6, if the target data TGT_DATA is programmed in the memory 110 at a time point A, then the tag information of the target data TGT_DATA may be determined as A.

Afterwards, if the target data TGT_DATA is updated or migrated at a time point B, then the tag information of the target data TGT_DATA may be determined as B.

Then, when the target data TGT_DATA is updated or migrated at a time point C, the tag information of the target data TGT_DATA may be determined as C.

When the tag information of the target data TGT_DATA is determined, the tag information of the map unit corresponding to the target data TGT_DATA may also be determined from the mapping table MAP_TBL.

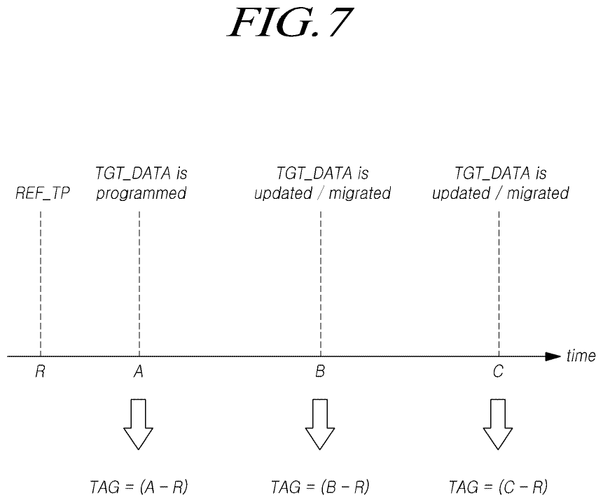

FIG. 7 illustrates another example of an operation for determining tag information of target data according to an embodiment of the present disclosure.

Referring to FIG. 7, a value of tag information of target data TGT_DATA may be a difference between a reference time point REF_TP and the time point at which the target data TGT_DATA was last programmed in the memory 110.

The reference time point REF_TP may be any time point. For example, the reference time point REF_TP may be the time point at which the target data TGT_DATA was first programmed in the memory 110. As another example, the reference time point REF_TP may be a time point at which a booting operation for a storage device 100 is completed. In FIG. 7, the value of the reference time point is R.

Then, when the target data TGT_DATA is programmed in the memory 110 at a time point A, the tag information of the target data TGT_DATA may be determined as (A-R).

Thereafter, if the target data TGT_DATA is updated or migrated at a time point B, then the tag information of the target data TGT_DATA may be determined as (B-R).

If the target data TGT_DATA is updated or migrated at a time point C, then the tag information of the target data TGT_DATA may be determined as (C-R).

Similar to FIG. 6, when the tag information of the target data TGT_DATA is determined, tag information of the map unit corresponding to the target data TGT_DATA may also be determined from a mapping table MAP_TBL.

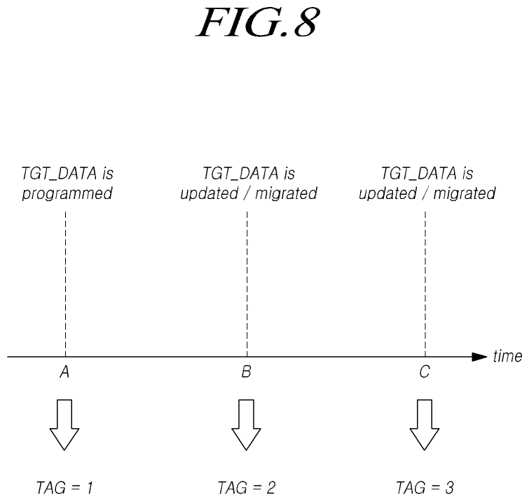

FIG. 8 illustrates another example of an operation for determining tag information of target data according to an embodiment of the present disclosure.

Referring to FIG. 8, a value of tag information of target data TGT_DATA may indicate the total number of times that the target data TGT_DATA has been programmed, updated, or migrated.

In FIG. 8, if target data TGT_DATA is programmed in the memory 110 at a time point A, the tag information of the target data TGT_DATA may be determined as 1.

Then, when the target data TGT_DATA is updated or migrated at a time point B, the tag information of the target data TGT_DATA may be determined as 2.

Afterwards, if the target data TGT_DATA is updated or migrated at a time point C, then the tag information of the target data TGT_DATA may be determined as 3.

Similar to FIG. 6, when the tag information of the target data TGT_DATA is determined, the tag information of a map unit corresponding to the target data TGT_DATA in a mapping table MAP_TBL may also be determined.

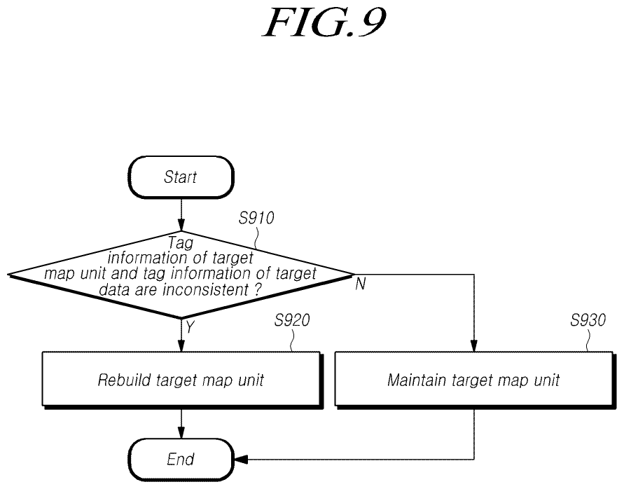

FIG. 9 is a flowchart illustrating an operation for determining whether a storage device rebuilds a target map unit according to an embodiment of the present disclosure.

Referring to FIG. 9, a controller 120 of a storage device 100 may determine whether tag information of target map unit TGT_MAP_UNIT and tag information of corresponding target data TGT_DATA are inconsistent or do not match (S910).

If the tag information of the target map unit TGT_MAP_UNIT and the tag information of the target data TGT_DATA are inconsistent (S910-Y), the controller 120 may rebuild the target map unit TGT_MAP_UNIT (S920).

When the tag information of the target map unit TGT_MAP_UNIT and the tag information of the target data TGT_DATA do not match, it may mean that the target map unit TGT_MAP_UNIT loaded into a host memory buffer HMB by a host has been rolled back to a previous version after loading the target map unit TGT_MAP_UNIT into the host memory buffer HMB.

If the target map unit TGT_MAP_UNIT is rolled back to a previous version, then the controller 120 cannot detect whether the target map unit was rolled back using techniques such as ECC or CRC because the roll back is not a detectable internal error of the target map unit TGT_MAP_UNIT.

If the controller 120 does not detect that the target map unit TGT_MAP_UNIT loaded into the host memory buffer HMB has been rolled back to a previous version, then the controller 120 may access an incorrect physical address during a read or write operation, which may cause a serious error.

Therefore, the controller 120 may detect this situation using tag information and prevent an error caused by a roll back by rebuilding the target map unit TGT_MAP_UNIT.

If the tag information of the target map unit TGT_MAP_UNIT and the tag information of the target data TGT_DATA are consistent (S910-N), then the controller 120 may maintain the target map unit TGT_MAP_UNIT without rebuilding (S930).

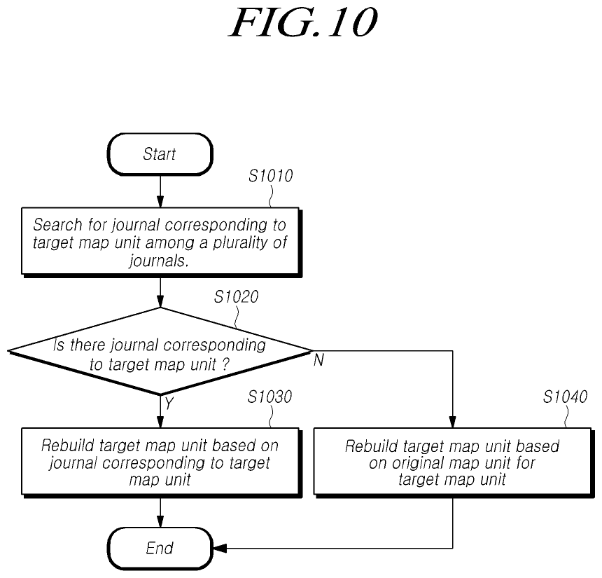

FIG. 10 is a flowchart illustrating an operation of a storage device rebuilding a target map unit according to an embodiment of the present disclosure.

Referring to FIG. 10, a controller 120 of a storage device 100 may search for a journal corresponding to a target map unit TGT_MAP_UNIT among a plurality of journals (S1010).

A memory 110 of the storage device 100 may store a plurality of journals indicating the change history of a mapping table MAP_TBL. For example, each journal may include information about a specific logical address and a newly mapped physical address for the specific logical address.

In addition, the controller 120 may determine whether there is a journal corresponding to the target map unit TGT_MAP_UNIT among the plurality of journals (S1020). The logical address included in the journal corresponding to the target map unit TGT_MAP_UNIT is also included in the target map unit TGT_MAP_UNIT.

If a journal corresponding to the target map unit TGT_MAP_UNIT exists (S1020-Y), then the controller 120 may rebuild the target map unit TGT_MAP_UNIT based on the journal corresponding to the target map unit TGT_MAP_UNIT (S1030). In this case, the controller 120 may execute an operation (i.e., a replay operation) that reflects the mapping relationship between a physical address and a logical address included in the journal corresponding to the target map unit TGT_MAP_UNIT to the target map unit TGT_MAP_UNIT.

If there is no journal corresponding to the target map unit TGT_MAP_UNIT (S1020-N), then the controller 120 may rebuild the target map unit TGT_MAP_UNIT based on an original map unit for the target map unit TGT_MAP_UNIT among the plurality of map units MAP_UNIT included in the mapping table MAP_TBL (S1040). In this case, the controller 120 may replace the target map unit TGT_MAP_UNIT with the original map unit.

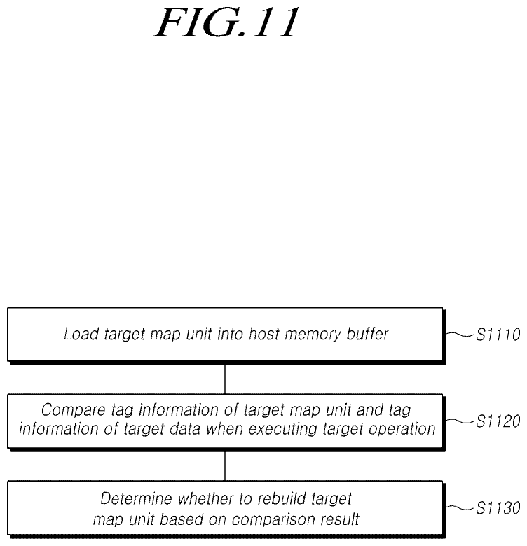

FIG. 11 illustrates an operating method of a storage device according to an embodiment of the present disclosure.

Referring to FIG. 11, an operating method of a storage device 100 may include a step (S1110) of loading a target map unit TGT_MAP_UNIT, from among a plurality of map units MAP_UNIT included in a mapping table MAP_TBL in a memory 110, into a host memory buffer HMB located outside the storage device 100.

In addition, the operating method of the storage device 100 may include a step (S1120) of comparing tag information of the target map unit TGT_MAP_UNIT with tag information of target data TGT_DATA corresponding to the target map unit TGT_MAP_UNIT when a set target operation is executed.

For example, the target operation may be an operation of reading the target map unit TGT_MAP_UNIT from the host memory buffer HMB, an operation of flushing the target map unit TGT_MAP_UNIT from the host memory buffer HMB to the memory 110, or an operation of scanning the validity of the target map unit TGT_MAP_UNIT.

For example, the tag information may indicate a time point when the target data TGT_DATA has been last programmed in the memory 110. In this case, the value of the tag information may be the difference between a reference time point and the time point when the target data TGT_DATA was last programmed in the memory 110.

In another example, the tag information may indicate the total number of times the target data TGT_DATA was programmed, updated, or migrated.

In addition, the operating method of the storage device 100 may include a step (S1130) of determining whether to rebuild the target map unit TGT_MAP_UNIT based on the comparison result of step S1120.

In addition, the operating method of the storage device 100 may further include a step of rebuilding the target map unit TGT_MAP_UNIT if the tag information of the target map unit TGT_MAP_UNIT and the tag information of the target data TGT_DATA do not match.

As an example, the step of rebuilding the target map unit TGT_MAP_UNIT may include a step of rebuilding the target map unit TGT_MAP_UNIT based on a journal corresponding to the target map unit TGT_MAP_UNIT, from among a plurality of journals indicating the change history of the mapping table MAP_TBL.

As another example, the step of rebuilding the target map unit TGT_MAP_UNIT may include a step of rebuilding the target map unit TGT_MAP_UNIT based on an original map unit for the target map unit TGT_MAP_UNIT, from among a plurality of map units MAP_UNIT included in the mapping table MAP_TBL, if there is no journal corresponding to the target map unit TGT_MAP_UNIT.

Although exemplary embodiments of the disclosure have been described for illustrative purposes, those skilled in the art will appreciate that various modifications, additions and substitutions are possible, without departing from the scope and spirit of the disclosure. Therefore, the embodiments disclosed above and in the accompanying drawings should be considered in a descriptive sense only and not for limiting the technological scope. The technological scope of the disclosure is not limited by the embodiments and the accompanying drawings. The spirit and scope of the disclosure should be interpreted in connection with the appended claims and encompass all equivalents falling within the scope of the appended claims.

What is claimed is:

1. A storage device comprising:
a memory storing a plurality of map units included in a mapping table that indicates a mapping relationship between a plurality of logical addresses and a plurality of physical addresses, each of the plurality of map units indicating a mapping relationship between one or more logical addresses and one or more physical addresses; and
a controller configured to load a target map unit, from among the plurality of map units, into a host memory buffer located outside the storage device, and when a target operation is executed, determine whether to rebuild the target map unit by comparing tag information of the target map unit with tag information of target data in the memory corresponding to the target map unit.

2. The storage device of claim 1, wherein the target operation includes an operation of reading the target map unit from the host memory buffer, an operation of flushing the target map unit from the host memory buffer to the memory, or an operation of scanning a validity of the target map unit.

3. The storage device of claim 1, wherein the tag information indicates a time point when the target data was last programmed into the memory.

4. The storage device of claim 3, wherein a value of the tag information is a difference between a reference time point and the time point when the target data was last programmed into the memory.

5. The storage device of claim 1, wherein the tag information indicates the total number of times the target data has been programmed, updated or migrated.

6. The storage device of claim 1, wherein the controller rebuilds the target map unit if the tag information of the target map unit and the tag information of the target data do not match.

7. The storage device of claim 6, wherein the memory stores a plurality of journals indicating a change history of the mapping table,
wherein the controller rebuilds the target map unit based on a journal, from among the plurality of journals, corresponding to the target map unit.

8. The storage device of claim 6, wherein the controller rebuilds the target map unit based on an original map unit for the target map unit, from among the plurality of map units included in the mapping table, when there is no journal corresponding to the target map unit.

9. An operating method of a storage device comprising:
loading a target map unit, from among a plurality of map units included in a mapping table that indicates a mapping relationship between a plurality of logical addresses and a plurality of physical addresses, from a memory storing the mapping table to a host memory buffer located outside the storage device;
comparing tag information of the target map unit with tag information of target data corresponding to the target map unit when a target operation is executed; and
determining whether to rebuild the target map unit based on a result of the comparison.

10. The operating method of claim 9, wherein the target operation includes an operation of reading the target map unit from the host memory buffer, an operation of flushing the target map unit from the host memory buffer to the memory, or an operation of scanning a validity of the target map unit.

11. The operating method of claim 9, wherein the tag information indicates a time point at which the target data was last programmed into the memory.

12. The operating method of claim 11, wherein a value of the tag information is a difference between a reference time point and the time point at which the target data has been last programmed into the memory.

13. The operating method of claim 9, wherein the tag information indicates the total number of times the target data has been programmed, updated or migrated.

14. The operating method of claim 9, further comprising rebuilding the target map unit if the tag information of the target map unit and the tag information of the target data are inconsistent.

15. The operating method of claim 14, wherein the rebuilding the target map unit includes rebuilding the target map unit based on a journal, from among a plurality of journals, corresponding to the target map unit indicating a change history of the mapping table.

16. The operating method of claim 14, wherein the rebuilding the target map unit includes rebuilding the target map unit based on an original map unit for the target map unit, among the plurality of map units included in the mapping table, if there is no journal corresponding to the target map unit.
